(19) United States
(12) Patent Application Publication
(10) Pub. No.: US 2013/0232382 A1
(43) Pub. Date: Sep. 5, 2013

(54) METHOD AND SYSTEM FOR DETERMINING THE IMPACT OF FAILURES IN DATA CENTER NETWORKS

(71) Applicants: Navendu Jain, Bellevue, WA (US); Phillipa Gill, Torornto (CA)

(72) Inventors: Navendu Jain, Bellevue, WA (US); Phillipa Gill, Torornto (CA)

(73) Assignee: MICROSOFT CORPORATION, Redmond, WA (US)

(21) Appl. No.: 13/409,111

(22) Filed: Mar. 1, 2012

(51) Int. Cl. G06F 11/07

(52) U.S. Cl. 714/48; 714/E11.024

(57) ABSTRACT

There is provided a method and system for determining an impact of failures in a data center network. The method includes identifying failures for the data center network based on data about the data center network and grouping the failures into failure event groups, wherein each failure event group includes related failures for a network element. The method also includes estimating the impact of the failures for each of the failure event groups by correlating the failures with traffic for the data center network.

### BACKGROUND

Demand for dynamic scaling and benefits from economies of scale are driving the creation of mega data center networks to host a broad range of services, such as Web search, electronic commerce (e-commerce), storage backup, video streaming, high-performance computing, and data analytics. To host these applications, data center networks need to be scalable, efficient, fault tolerant, and manageable. Thus, several architectures have been proposed to improve the scalability and performance of data center networks. However, the issue of reliability of data center networks has remained unaddressed, mainly due to a dearth of available empirical data on failures in these networks.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a system and method for characterizing network failure patterns in data center networks. An embodiment provides a method for determining the impact of failures in a data center network. The method includes identifying a number of failures for the data center network based on data about the data center network and grouping the failures into a number of failure event groups, wherein each failure event group includes a number of related failures for a network element. The method also includes estimating the impact of the failures for each of the failure event groups by correlating the failures with traffic for the data center network.

Another embodiment provides a system for determining the impact of failures in a data center network. The system includes a processor that is adapted to execute stored instructions and a system memory. The system memory includes code configured to identify a number of failures for the data center network based on data about the data center network. The system memory also includes code configured to group the failures into a number of failure event groups, wherein each failure event group includes a number of related failures for a network element. The system memory further includes code configured to estimate the impact of the failures for each of the failure event groups by correlating the failures with traffic for the data center network and data from multiple data sources.

In addition, another embodiment provides one or more non-transitory, computer-readable storage media for storing computer-readable instructions. The computer-readable instructions provide a system for analyzing an impact of failures in a data center network when executed by one or more processing devices. The computer-readable instructions include code configured to identify a number of failures for the data center network based on data about the data center network. The computer-readable instructions also include code configured to group the failures into a number of failure event groups, wherein each failure event group includes a number of related failures for a network element. The computer-readable instructions further include code configured to estimate the impact of the failures for each of the failure event groups by correlating the failures with a change in an amount of network traffic for the data center network and determine the effectiveness of network redundancies in masking the impact of the failures for each of the failure event groups.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a schematic of an example data center network architecture in accordance with the claimed subject matter;

FIG. 2 is a schematic illustrating the use of network redundancies to mask failures within the data center network in accordance with the claimed subject matter;

FIG. 3A is a graph illustrating the distribution of network link failures for a data center network in accordance with the claimed subject matter;

FIG. 3B is a graph illustrating the distribution of network link failures with impact for the data center network in accordance with the claimed subject matter;

FIG. 4 is a process flow diagram of a method for determining the impact of failures in data center networks in accordance with the claimed subject matter;

FIG. 5 is a process flow diagram of a method for determining the impact of failures of devices within data center networks in accordance with the claimed subject matter;

FIG. 6 is a process flow diagram of a method for determining the impact of failures of links within data center networks in accordance with the claimed subject matter;

FIG. 7 is a process flow diagram of a method for determining the impact of failures of one or more components in network redundancy groups within data center networks in accordance with the claimed subject matter;

FIG. 8 is a block diagram of a networking environment in which a system and method for determining the impact of failures in data center networks may be implemented; and

FIG. 9 is a block diagram of a computing environment that may be used to implement a system and method for determining the impact of failures in data center networks.

### DETAILED DESCRIPTION

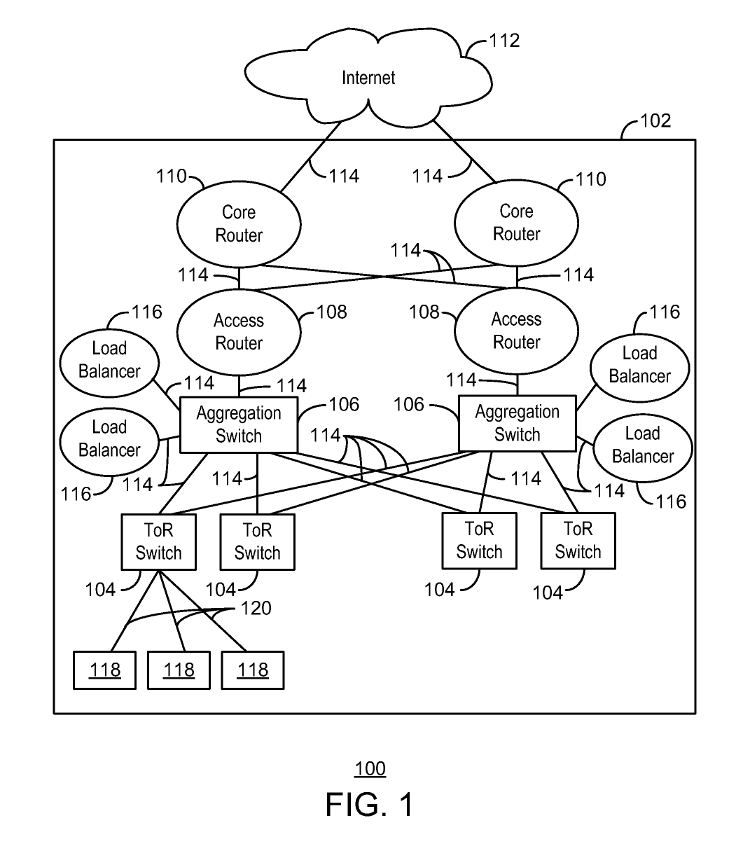

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As used herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

As used herein, terms “component,” “search engine,” “browser,” “server,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory, computer-readable device, or media. Non-transitory, computer-readable storage media can include, but are not limited to, tangible magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Embodiments disclosed herein set forth a method and system for determining the impact of failures in a data center network. Such failures result from the improper functioning of certain network elements, wherein network elements include network devices (e.g., routers, switches or middle boxes, among others) and network links. Data about the data center network may be used to determine the types of failures that have occurred, e.g., the particular network elements that have failed and the duration of the failures. Such data may include data obtained from network event logs of failure notifications, data obtained from network operations center (NOC) tickets, network traffic data, and network topology data. The information obtained from any of these data sources may be used to group the failures into a number of failure event groups. Each failure event group may include a number of related failures for a particular network element. Further, each failure event group may correspond to all of the failure notifications that resulted from a single failure event for the network element. For each failure event group, the impact of the failures may be estimated by analyzing the network traffic for the particular network element. In various embodiments, a failure, or failure event, may be considered to impact the data center network if an amount of network traffic during the duration of the failure is less than an amount of network traffic before the failure.

In various embodiments, network redundancies may be implemented within the data center network in order to mask the impact of the failures on the data center network. Data center networks typically provide 1:1 redundancy, meaning that each route of traffic flow has an alternate route that may be used if a failure occurs. In other words, if a primary network link fails, there is usually a backup network link through which network traffic may flow. Similarly, if a primary network device fails, there is usually a backup network device that is communicably coupled to the primary network device through a network link and is capable of accepting rerouted network traffic from the primary network device.

FIG. 1 is a schematic 100 of an example data center network architecture 102 in accordance with the claimed subject matter. The data center network architecture 102 may be used to connect, or “dual-home,” a number of rack-mounted servers 118 to a number of Top of Rack (ToR) switches 104, usually via 1 Gbps links 120. The ToR switches 104 may be connected to a number of aggregation switches 106. The aggregation switches 106 may be used to combine network traffic from the ToR switches 104 and forward such network traffic to a number of access routers 108. The access routers 108 may be used to aggregate network traffic from a large number of servers, e.g., on the order to several thousand servers, and route the network traffic to a number of core routers 110. The core routers 110 are configured to communicably couple the data center network architecture 102 to the Internet 112.

All of the components of the data center network architecture 102 discussed above may be connected by a number of network links 114. In some embodiments, the network links 114 may use Ethernet as the link layer protocol, and the physical connections for the network links 114 may be a mixture of copper and fiber cables. In addition, in some embodiments, the servers may be partitioned into virtual LANs (VLANs) to limit overheads (e.g., ARP broadcasts, and packet flooding) and to isolate different applications hosted in the data center network.

In various embodiments, the data center network architecture 102 may also include a number of middle boxes, such as load balancers 116 and firewalls. For example, as shown in FIG. 1, pairs of load balancers 116 may be connected to each aggregation switch 106 and may perform mapping between static IP addresses and dynamic IP addresses of the servers that process user requests. In addition, for some applications, the load balancers 116 may be reprogrammed, and their software and configurations may be upgraded to support different functionalities.

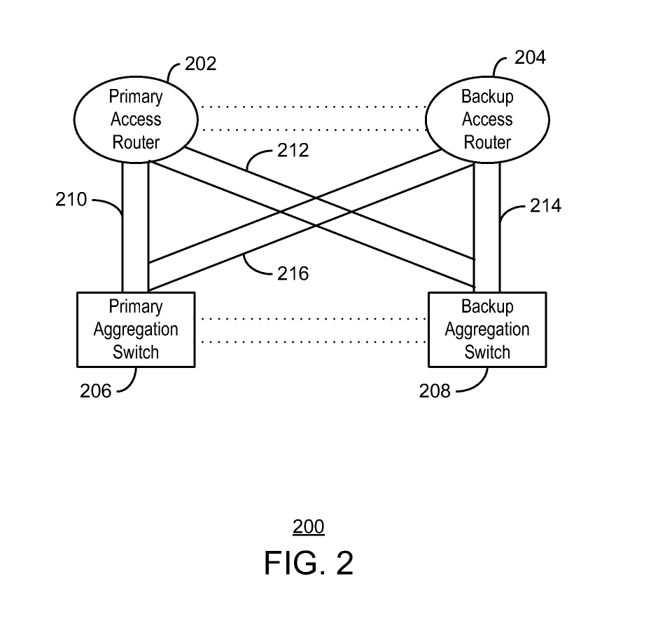

At each layer of the data center network topology, 1:1 redundancy may be built into the data center network architecture 102 to mitigate the impact of failures. Such network redundancies are discussed further below with respect to FIG. 2.

FIG. 2 is a schematic 200 illustrating the use of network redundancies to mask failures within the data center network in accordance with the claimed subject matter. In various embodiments, such network redundancies may be implemented within the data center network architecture 102 described with respect to FIG. 1. In general, a failure within the data center network may be attributed to the failure of a network device or the failure of a network link. Thus, it is desirable to have more than one of each type of network device and network link in order to ensure the reliability of the data center network.

As shown in FIG. 2, the data center network may include a primary access router 202 linked with a backup access router 204, as well as a primary aggregation switch 206 linked with a backup aggregation switch 208. In various embodiments, the primary access router 202 and the backup access router 204 may be the access routers 108 described with respect to FIG. 1, while the primary aggregation switch 206 and the backup aggregation switch 208 may be the aggregation switches 106 described with respect to FIG. 1. The implementation of a primary and a backup for each type of network device increases the likelihood that network traffic may continue to flow uninterruptedly despite possible network device failures. Thus, such network redundancies may mitigate the impact of failures within the data center network.

The data center network may also include multiple network links in order to provide additional network redundancies. For example, as shown in FIG. 2, a first network link 210 may connect the primary access router 202 to the primary aggregation switch 206, while a second network link 212 may connect the primary access router 202 to the backup aggregation switch 208. In various embodiments, the first network link 210 may be the initial route of flow for network traffic. However, if the first network link 210 fails, the network traffic may instead flow through the second network link 212 to the backup aggregation switch 208. In addition, network traffic may be rerouted through the second network link 212 if the primary aggregation switch 206 fails.

A third network link 214 may connect the backup access router 204 to the backup aggregation switch 208, while a fourth network link 216 may connect the backup access router 204 to the primary aggregation switch 206. If the primary access router 202 fails, the fourth network link 216 may be used to send network traffic from the backup access router 204 to the primary aggregation switch 206, since the primary aggregation switch 206 is generally utilized instead of the backup aggregation switch 208. However, if the primary aggregation switch 206 or the fourth network link 216 fails, the third network link 214 may be used to send network traffic from the backup access router 204 to the backup aggregation switch 208. Thus, network redundancies may enable the data center network to reroute network traffic from an initial route of flow to an alternate route of flow when a failure occurs along the initial route of flow. The network redundancy is typically 1:1, with a primary and backup router and switch. However, in some cases, there may be a larger number of devices and links in a redundancy group.

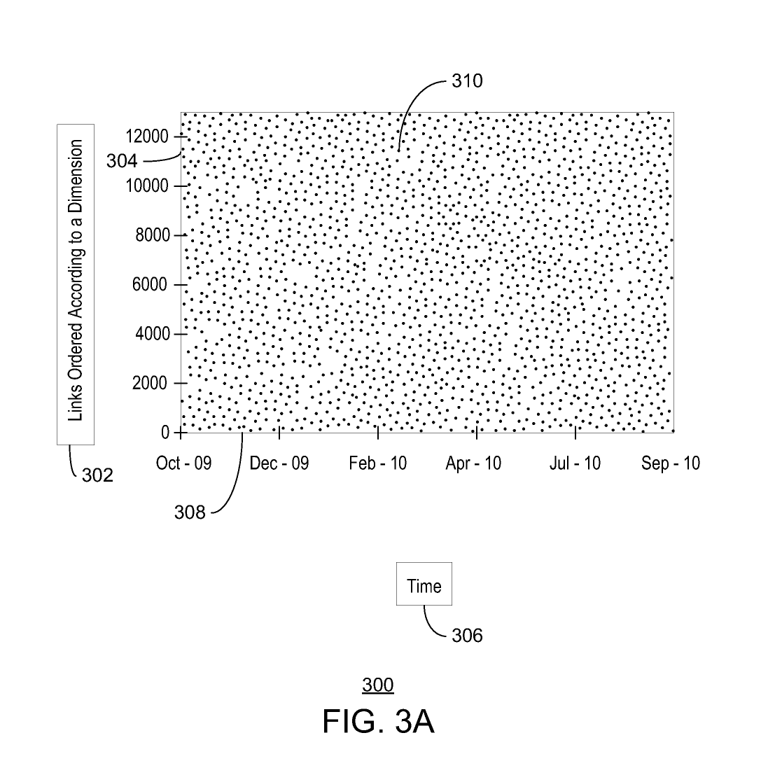

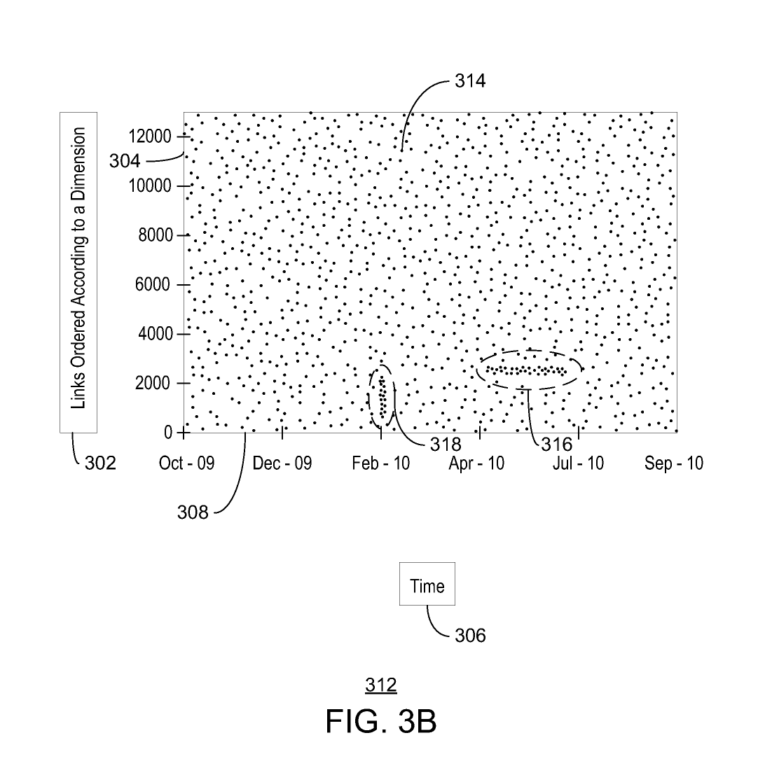

FIG. 3A is a graph 300 illustrating the distribution of network link failures for the data center network in accordance with the claimed subject matter. The graph 300 may be a two-dimensional graph. A number of links ordered according to a dimension 302 may be represented along the y-axis 304. Being ordered according to a dimension represents an ordering by, for example, data center or device type or application. Additionally, time 306 may be represented along the x-axis 308. The number of network links 302 may range, for example, from 0 to 12,000, as shown in FIG. 3A. The time 306 may range, for example, from October 2009 to September 2010, as shown in FIG. 3A.

Each of a number of points 310 within the graph 300 represents an occurrence of a failure for the corresponding network link 302 at the corresponding time 306. In other words, each of the points 310 indicates that the network link (y) experienced at least one failure on a given day (x). The failures may be determined from data about the data center network, such as data obtained from network event logs of failure notifications, data obtained from network operations center (NOC) tickets, network traffic data, and network topology data, external watchdog monitoring systems and maintenance tracking system. The failures may include all occurrences of network link failures within the data center network, including those resulting from planned maintenance of the data center network. However, because some failures may not have an impact on the data center network, it is desirable to modify the graph 300 to include only failures with impact.

FIG. 3B is a graph 312 illustrating the distribution of network link failures with impact for the data center network in accordance with the claimed subject matter. A failure may be considered to impact the data center network if an amount of network traffic during the failure is less than an amount of network traffic before the failure. Therefore, each network link failure may be correlated with network traffic observed on the network link 302 in the recent past before the time 306 of the failure. For example, in various embodiments, the traffic on the link (e.g., as measured using five minute traffic averages) may be analyzed for each network link 302 that failed, and the amount of network traffic on the network link 302 in the window preceding the failure event may be compared to the amount of network traffic on the network link 302 during the failure event (e.g., by comparing a percentile, such as the median, mean, or 95^{th} percentile) in order to determine whether the data center network has been impacted.

Further, in some embodiments, network links 302 that were not transferring data before or after the failure event, i.e., inactive network links, may not be considered to have an impact on the data center network. In addition, network links 302 that were not transferring data before the failure event, but were transferring some data after the failure event, i.e., provisioning network links, may not be considered to have an impact on the data center network. Thus, inactive network link failures and provisioning network link failures may be automatically excluded from the graph 312.

Each of a number of points 314 within the graph 312 represents an occurrence of a failure with impact for the corresponding network link 302 at the corresponding time 306. An occurrence of a number of horizontally-aligned points 316 indicates a network link failure for a particular network link 302 that is long-lived, i.e., that spans a wide period of time 306. An occurrence of a number of vertically-aligned points 318 indicates a number of network link failures that are spatially widespread, i.e., that occur for a number of separate network links 302 within the data center network at a specific point in time 306. The recognition of such patterns and associations between network link failures for the data center network may be useful for the identification and resolution of the underlying issues within the data center network.

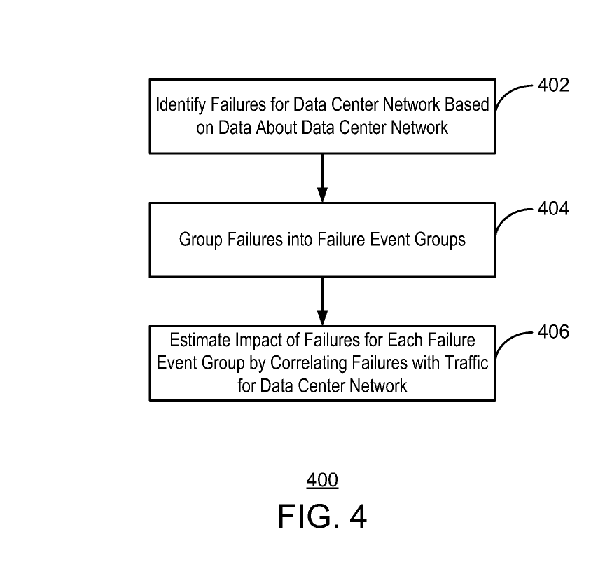

FIG. 4 is a process flow diagram of a method 400 for determining the impact of failures in data center networks in accordance with the claimed subject matter. In various embodiments, the data center networks that may be analyzed according to the method 400 may each include a number of communicably coupled network elements, such as aggregation switches, Top of Rack (ToR) switches, inter-data center links, load balancers, load balancer links, access routers, and core routers, among others. The method 400 begins at block 402 with the identification of a number of failures for the data center network based on data about the data center network. In various embodiments, such data includes low-level network data. The data may be obtained from network event logs of failure notifications, network operations center (NOC) tickets, network traffic data, or network topology data, among others.

The failures for the data center network may include network link failures or network device failures. A network device failure may indicate an improper functioning of a network device within the data center network. The improper functioning may include, for example, an inability to properly route or forward network traffic. A network link failure may indicate a loss of connection between two or more network devices within the data center network.

At block 404, the failures may be grouped into a number of failure event groups. Each failure event group may include a number of related failures for a network element, wherein the network element may be a network link or a network device. In some embodiments, the related failures within a particular failure event group include failures that occur within a specified period of time, wherein the specified time period is the duration of the corresponding failure event. For example, multiple failure events for a single network element that occur at the same time are grouped into one failure event group. In addition, failure events for a single network element that is already “down,” i.e., has failed and has not come back online, are grouped into one failure event group. In both cases, if the failures within a particular failure event group do not have the same duration, the earliest end time for the failures within the failure event group may be considered to be the end time for all of the failures within the failure event group. In various embodiments, network event log entries may be used to determine the duration, as well as the start time and end time, of each failure within a failure event group.

At block 406, the impact of the failures for each failure event group may be estimated by correlating the failures with network traffic for the data center network. The impact of the failures may be also be estimated by correlating the failures with data from multiple data sources, including, for example, network event logs of failure notifications and network operations center (NOC) tickets. In various embodiments, estimating the impact of a particular failure may include computing a statistical measure (e.g., median, 95^{th} percentile, or mean) of the amount of data (e.g., the number of packets or number of bytes transferred per second) transmitted on a network link in a specified period of time preceding a failure, computing a statistical measure of the amount of data transmitted on the network link during the failure, and using that information to calculate the change in the amount of data that was transferred during the duration of the failure. As used herein, the term “packet” refers to a group of bytes that are transferred across the network link. The change in the amount of data that was transferred may be calculated by subtracting the statistical measure of the amount of data transmitted on the network link during the failure from the statistical measure of the amount of data transmitted on the network link in the specified period of time preceding the failure to obtain a first value, and multiplying the first value by a duration of the failure (e.g., the duration in seconds), to obtain an estimate of the change in the amount of data (e.g., the number of packets or number of bytes) that was transferred during the duration of the failure. In some embodiments, the amount data that was transmitted on the network link after the failure may also be observed to help determine the impact of the failure. Further, in various embodiments, the impact of the failure may be a loss of traffic data during a failure compared to its value before the failure.

It is to be understood that the method 400 is not intended to indicate that all of the steps of the method 400 are to be included in every case. Further, any number of additional steps may be included within the method 400, depending on the specific application. For example, an effectiveness of network redundancies in masking the impact of the failures may be determined. This may be accomplished, for example, by determining an ability of the data center network to reroute network traffic from an initial route of flow to an alternate route of flow when a failure occurs along the initial route of flow.

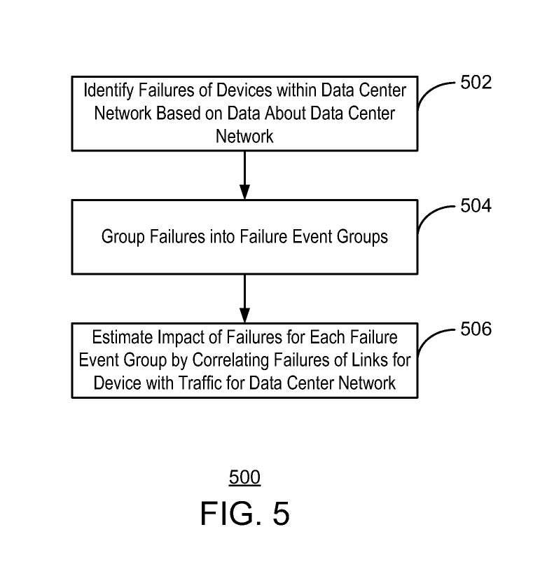

FIG. 5 is a process flow diagram of a method 500 for determining the impact of failures of devices within data center networks in accordance with the claimed subject matter. The method begins at block 502, at which failures of devices within the data center network are identified based on data about the data center network. In various embodiments, data about the data center network that is used to identify the failures may be the same as that discussed above with respect to block 402 of FIG. 4. The failure of a device may be identified based on the change in amount of network traffic across links that are connected to the particular device. In some embodiments, if multiple links that are connected to the same device are not functioning properly, there may be a failure within the device itself, rather than within the individual links.

At block 504, the failures may be grouped into failure event groups. Each of the failure event groups may include failures relating to a specific device. For example, a failure event group may include failures of all links that are connected to a particular device, as well as any failures of the device itself.

At block 506, the impact of the failures for each failure event group may be estimated by correlating failures of links for a device with traffic for the data center network. In addition, the impact of the failures for each failure event group may be estimated by correlating across multiple data sources, such as, for example, network event logs of failure notifications and network operations center (NOC) tickets. In various embodiments, if the failure of the device resulted in a reduction in traffic relative to a traffic value before the failure, across multiple links that are connected to the device, then the failure of the device may be assumed to be impactful.

It is to be understood that the method 500 is not intended to indicate that all of the steps of the method 500 are to be included in every case. Further, any number of additional steps may be included within the method 500, depending on the specific application.

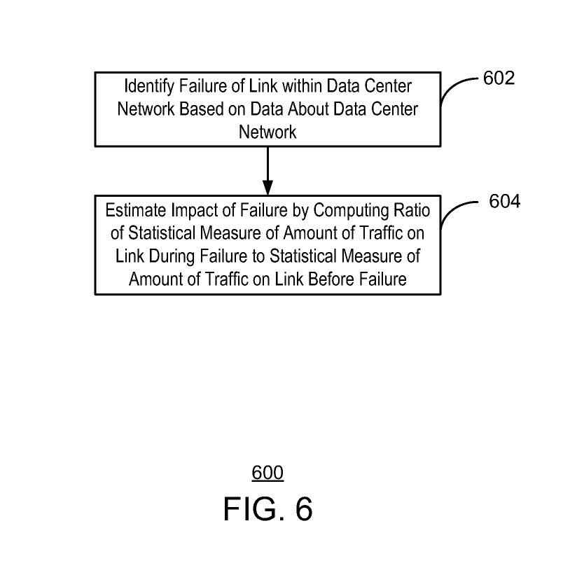

FIG. 6 is a process flow diagram of a method 600 for determining the impact of failures of links within data center networks in accordance with the claimed subject matter. The method begins at block 602 with the identification of a failure of a link within the data center network based on data about the data center network. In various embodiments, data about the data center network that is used to identify the failures may be the same as that discussed above with respect to block 402 of FIG. 4.

At block 604, the impact of the failure of the link may be estimated by computing a ratio of a statistical measure of the amount of traffic on the link during the failure to a statistical measure of the amount of traffic on the link before the failure. In various embodiments, the statistical measure is a median. If the ratio is less than 1, this indicates that traffic was lost during the failure, since the amount of data transferred during the failure was less than the amount of data transferred before the failure.

It is to be understood that the method 600 is not intended to indicate that all of the steps of the method 600 are to be included in every case. Further, any number of additional steps may be included within the method 600, depending on the specific application.

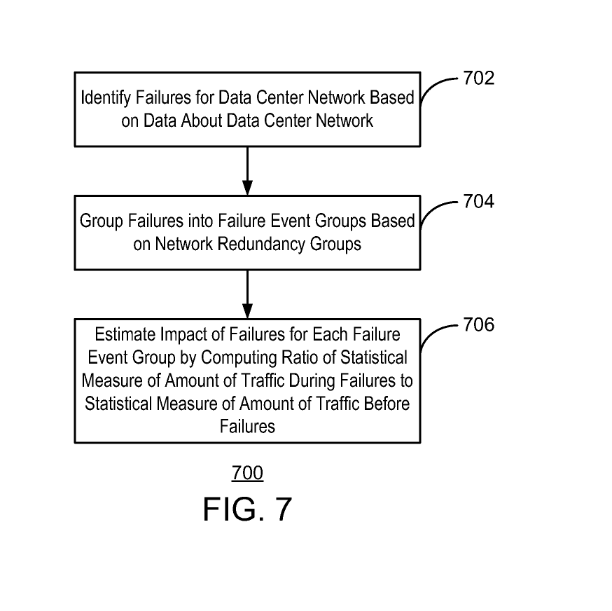

FIG. 7 is a process flow diagram of a method 700 for determining the impact of failures of one or more components in network redundancy groups within data center networks in accordance with the claimed subject matter. The method begins at block 702 with the identification of failures for the data center network based on data about the data center network. In various embodiments, data about the data center network that is used to identify the failures may be the same as that discussed above with respect to block 402 of FIG. 4.

At block 704, the failures may be grouped into failure event groups based on the network redundancy groups. For example, each failure event group may include all of the links and devices that are included within a particular network redundancy group.

At block 706, the impact of the failures for each failure event group may be estimated by computing a ratio of a statistical measure of the amount of traffic during the failures to a statistical measure of the amount of traffic before the failures. If the ratio is less than 1, this indicates that traffic was lost during the failure, since the amount of data transferred during the failure was less than the amount of data transferred before the failures. In various embodiments, the statistical measure is a median.

In a well-designed network, many failures may be masked by redundant groups of devices and links. The effectiveness of redundancy is estimated by computing this ratio on a per-link basis, as well as across all links in the redundancy group where the failure occurred. If a failure has been masked completely, this ratio will be close to one across a redundancy group. In other words, traffic during failure is equal to the traffic before the failure, across a redundancy group.

It is to be understood that the method 700 is not intended to indicate that all of the steps of the method 700 are to be included in every case. Further, any number of additional steps may be included within the method 700, depending on the specific application.

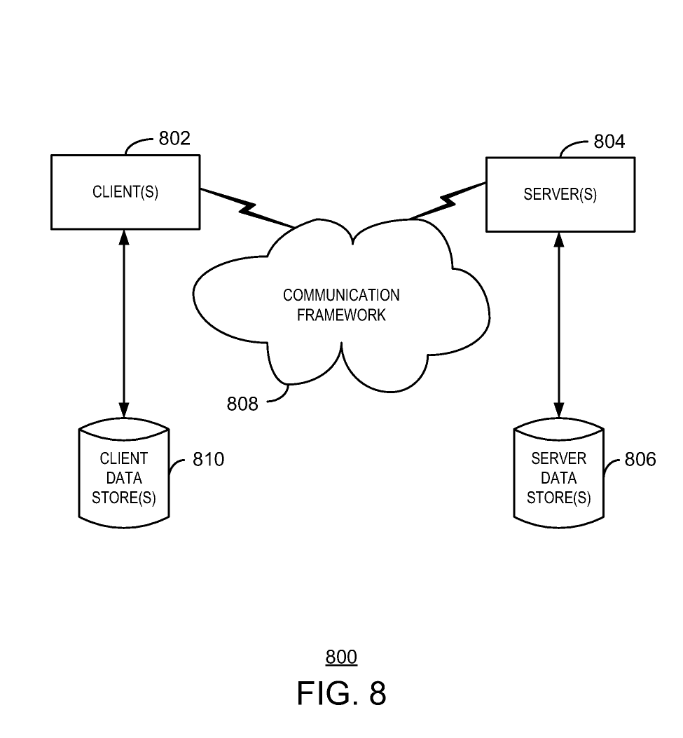

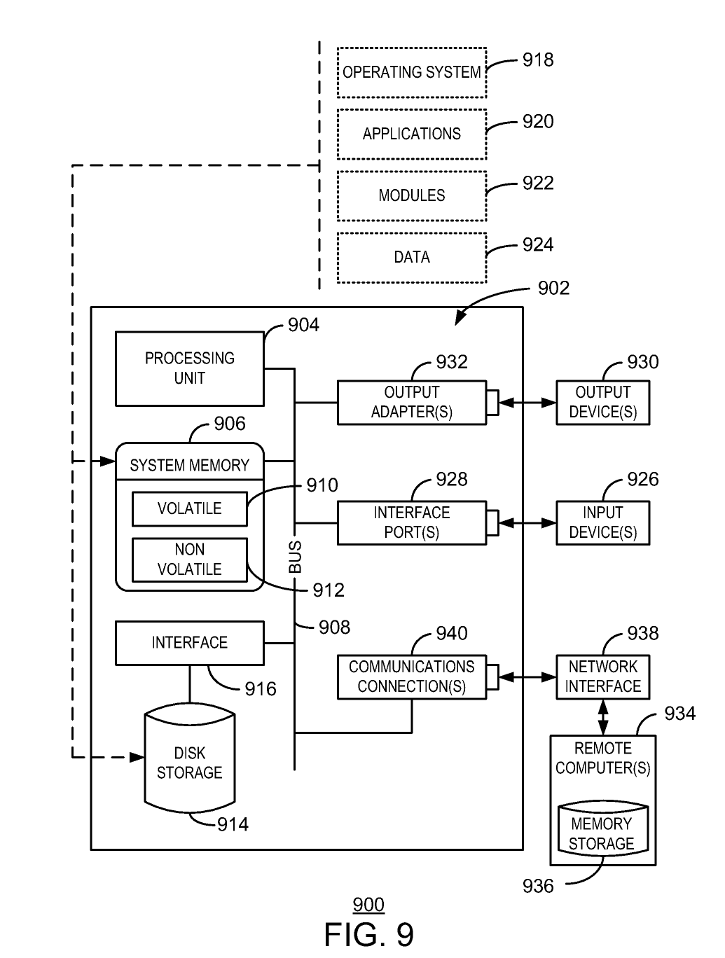

In order to provide additional context for implementing various aspects of the claimed subject matter, FIGS. 8-9 and the following discussion are intended to provide a brief, general description of a suitable computing environment in which the various aspects of the subject innovation may be implemented. For example, a method and system for determining an impact of network link failures and network device failures in data center networks can be implemented in such a suitable computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, etc., that perform particular tasks or implement particular abstract data types.

Moreover, those of skill in the art will appreciate that the subject innovation may be practiced with other computer system configurations, including single-processor or multi-processor computer systems, minicomputers, mainframe computers, as well as personal computers, hand-held computing devices, microprocessor-based or programmable consumer electronics, and the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 8 is a block diagram of a networking environment 800 in which a system and method for determining the impact of failures in data center networks may be implemented. The networking environment 800 includes one or more client(s) 802. The client(s) 802 can be hardware and/or software (e.g., threads, processes, or computing devices). The networking environment 800 also includes one or more server(s) 804. The server(s) 804 can be hardware and/or software (e.g., threads, processes, or computing devices). The servers 804 can house threads to perform search operations by employing the subject innovation, for example.

One possible communication between a client 802 and a server 804 can be in the form of a data packet adapted to be transmitted between two or more computer processes. The networking environment 800 includes a communication framework 808 that can be employed to facilitate communications between the client(s) 802 and the server(s) 804. The client(s) 802 are operably connected to one or more client data store(s) 810 that can be employed to store information local to the client(s) 802. The client data store(s) 810 may be stored in the client(s) 802, or may be located remotely, such as in a cloud server. Similarly, the server(s) 804 are operably connected to one or more server data store(s) 806 that can be employed to store information local to the servers 804.

FIG. 9 is a block diagram of a computing environment 900 that may be used to implement a system and method for determining the impact of failures in data center networks. The computing environment 900 includes a computer 902. The computer 902 includes a processing unit 904, a system memory 906, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structures, including the memory bus or memory controller, a peripheral bus or external bus, or a local bus using any variety of available bus architectures known to those of ordinary skill in the art. The system memory 906 is non-transitory, computer-readable media that includes volatile memory 910 and nonvolatile memory 912. The basic input/output system (BIOS), containing the basic routines to transfer information between elements within the computer 902, such as during start-up, is stored in nonvolatile memory 912. By way of illustration, and not limitation, nonvolatile memory 912 can include read-only memory (ROM), programmable ROM (PROM), electrically-programmable ROM (EPROM), electrically-erasable programmable ROM (EEPROM), or flash memory.

Volatile memory 910 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 902 also includes other non-transitory, computer-readable media, such as removable/non-removable, volatile/non-volatile computer storage media. FIG. 9 shows, for example, a disk storage 914. Disk storage 914 includes, but is not limited to, devices like a magnetic disk drive, floppy disk drive, tape drive, Jaz drive, Zip drive, LS-100 drive, flash memory card, or memory stick.

In addition, disk storage 914 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 914 to the system bus 908, a removable or non-removable interface is typically used, such as interface 916.

It is to be appreciated that FIG. 9 describes software that acts as an intermediary between users and the basic computer resources described in the computing environment 900. Such software includes an operating system 918. Operating system 918, which can be stored on disk storage 914, acts to control and allocate resources of the computer 902.

System applications 920 take advantage of the management of resources by operating system 918 through program modules 922 and program data 924 stored either in system memory 906 or on disk storage 914. It is to be appreciated that the claimed subject matter can be implemented with various operating systems or combinations of operating systems.

A user enters commands or information into the computer 902 through input devices 926. Input devices 926 include, but are not limited to, a pointing device (such as a mouse, trackball, stylus, or the like), a keyboard, a microphone, a joystick, a satellite dish, a scanner, a TV tuner card, a digital camera, a digital video camera, a web camera, or the like. The input devices 926 connect to the processing unit 904 through the system bus 908 via interface port(s) 928. Interface port(s) 928 include, for example, a serial port, a parallel port, a game port, and a universal serial bus (USB). Output device(s) 930 may also use the same types of ports as input device(s) 926. Thus, for example, a USB port may be used to provide input to the computer 902, and to output information from computer 902 to an output device 930.

Output adapter 932 is provided to illustrate that there are some output devices 930 like monitors, speakers, and printers, among other output devices 930, which are accessible via adapters. The output adapters 932 include, by way of illustration and not limitation, video and sound cards that provide a means of connection between the output device 930 and the system bus 908. It can be noted that other devices and/or systems of devices provide both input and output capabilities, such as remote computer(s) 934.

The computer 902 can be a server hosting a search engine site in a networking environment, such as the networking environment 800, using logical connections to one or more remote computers, such as remote computer(s) 934. The remote computer(s) 934 may be client systems configured with web browsers, PC applications, mobile phone applications, and the like. The remote computer(s) 934 can be a personal computer, a server, a router, a network PC, a workstation, a microprocessor based appliance, a mobile phone, a peer device or other common network node and the like, and typically includes many or all of the elements described relative to the computer 902. For purposes of brevity, the remote computer(s) 934 is illustrated with a memory storage device 936. Remote computer(s) 934 is logically connected to the computer 902 through a network interface 938 and then physically connected via a communication connection 940.

Network interface 938 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 940 refers to the hardware/software employed to connect the network interface 938 to the system bus 908. While communication connection 940 is shown for illustrative clarity inside computer 902, it can also be external to the computer 902. The hardware/software for connection to the network interface 938 may include, for example, internal and external technologies such as, mobile phone switches, modems including regular telephone grade modems, cable modems and DSL modems, ISDN adapters, and Ethernet cards.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining an impact of failures in a data center network, comprising:
identifying a plurality of failures for the data center network based on data about the data center network;
grouping the plurality of failures into a plurality of failure event groups, wherein each failure event group comprises a plurality of related failures for a network element; and
estimating the impact of the plurality of failures for each of the failure event groups by correlating the plurality of failures with traffic for the data center network.

2. The method of claim 1, wherein estimating the impact of the plurality of failures comprises:
computing a statistical measure of an amount of data transferred on a network link in a specified period of time;
computing a statistical measure of an amount of data transferred on the network link during the specified period of time; and
calculating a change in an amount of data that was transferred during the specified period of time based on the statistical measure.

3. The method of claim 2, wherein the specified period of time comprises a period of time preceding a failure, a period of time of the failure, or a period of time after the failure, or any combinations thereof.

4. The method of claim 2, wherein calculating the change in the amount of data comprises:
subtracting the statistical measure of the amount of data transferred on the network link during the period of the failure from the statistical measure of the amount of data transferred on the network link in the period preceding the failure to obtain a first value; and
multiplying the first value by a duration of the failure to obtain an estimate of the change in the amount of data that was transferred during the duration of the failure.

5. The method of claim 1, wherein estimating the impact of the plurality of failures comprises estimating an impact of a failure on a link by computing a ratio of a statistical measure of an amount of traffic on the link during the failure to a statistical measure of an amount of traffic on the link before the failure.

6. The method of claim 1, comprising determining an impact of a failure of a network device by applying the method of claim 1 across links and devices.

7. The method of claim 1, comprising estimating the impact of the plurality of failures based on a correlation across multiple data sources.

8. The method of claim 1, comprising:
determining an effectiveness of a network redundancy group of redundant network components comprising devices and links, in masking an impact of the plurality of failures for each of the plurality of failure event groups, by estimating a change in an amount of network traffic due to the plurality of failures by:
computing a statistical measure of an amount of data transferred on network links in a specified period of time preceding the failures;
computing a statistical measure of an amount of data transferred on the network links during the failures; and
calculating a change in an amount of data that was transferred during the failures based on a statistical measure across the network redundancy group.

9. The method of claim 8, wherein the statistical measure comprises a median.

10. A system for determining an impact of failures in a data center network, comprising:
a processor that is adapted to execute stored instructions; and
a system memory, wherein the system memory comprises code configured to:
identify a plurality of failures for the data center network based on data about the data center network;
group the plurality of failures into a plurality of failure event groups, wherein each failure event group comprises a plurality of related failures for a network element; and
estimate the impact of the plurality of failures for each of the plurality of failure event groups by correlating the plurality of failures with traffic for the data center network and data from multiple data sources.

11. The system of claim 10, wherein the system memory comprises code configured to determine an effectiveness of network redundancy groups in masking the impact of the plurality of failures for each of the plurality of failure event groups.

12. The system of claim 10, wherein the code configured to estimate the impact of the plurality of failures comprises code configured to:
compute a statistical measure of an amount of data transferred on a network link in a specified period of time;
compute a statistical measure of an amount of data transferred on the network link during the specified period; and
calculate a change in an amount of data that was transferred during the specified period based on the statistical measure.

13. The system of claim 10, wherein the impact of the plurality of failures comprises a change in an amount of network traffic due to the plurality of failures.

14. The system of claim 10, wherein estimating the impact of the plurality of failures comprises estimating an impact of a failure on a link by computing a ratio of a statistical measure of an amount of traffic on the link during the failure to a statistical measure of an amount of traffic on the link before the failure.

15. The system of claim 10, comprising estimating an effectiveness of network redundancy by computing a ratio of a statistical measure of an amount of traffic on links and devices within a network redundancy group during the failure to a statistical measure of an amount of traffic on the links and the devices within the network redundancy group before the failure.

16. One or more non-transitory, computer-readable storage media for storing computer-readable instructions, the computer-readable instructions providing a system for analyzing an impact of failures in a data center network when executed by one or more processing devices, the computer-readable instructions comprising code configured to:
identify a plurality of failures for the data center network based on data about the data center network, wherein the plurality of failures comprises one or more of a network device failure or a network link failure;
group the plurality of failures into a plurality of failure event groups, wherein each failure event group comprises a plurality of related failures for a network element;
determine the impact of the plurality of failures for each of the plurality of failure event groups by correlating the plurality of failures with a change in an amount of network traffic; and
determine an effectiveness of network redundancies in mitigating the impact of the plurality of failures for each of the plurality of failure event groups.

17. The one or more non-transitory, computer-readable storage media of claim 16, wherein the plurality of related failures for the network element comprises a plurality of failures that occur for the network element within a specified period of time, and wherein the specified period of time comprises a duration of a particular failure event.

18. The one or more non-transitory, computer-readable storage media of claim 16, comprising code configured to determine an impact of a failure based on network topology data representing how a plurality of network elements are communicatively connected.

19. The one or more non-transitory, computer-readable storage media of claim 16, comprising code configured to determine an impact of a failure on a link by computing a ratio of a statistical measure of an amount of traffic on the link during the failure to a statistical measure of an amount of traffic on the link before the failure.

20. The one or more non-transitory, computer-readable storage media of claim 16, wherein determining the effectiveness of network redundancies comprises computing a ratio of a statistical measure of an amount of traffic on links and devices within a network redundancy group during the failure to a statistical measure of an amount of traffic on the links and the devices within the network redundancy group before the failure.
